(19) United States
(12) Patent Application Publication
(10) Pub. No.: US 2022/0129630 A1
(43) Pub. Date: Apr. 28, 2022

(54) Method For Detection Of Malicious Applications

(71) Applicant: CHECK POINT SOFTWARE TECHNOLOGIES LTD., Tel Aviv (IL)

(72) Inventors: Nadav George COSTA, Ramat Gan (IL); Eyal Balla, Ramat Gan (IL); Israel Wernik, Karmiel (IL)

(21) Appl. No.: 17/081,115

(22) Filed: Oct. 27, 2020

(51) Int. Cl. G06F 40/289

(52) U.S. Cl. CPC G06F 40/289

(57) ABSTRACT

Systems and computerized and computer-implemented methods operate to detect malicious applications (APPs). A method, which is performed on a suitably designed computerized system, comprises: obtaining text associated with an application; inputting a representation of the text into a classifier; and, the classifier processing the representation of the text. The classifier processes the representation of the text by processes including: applying weights to words of the text for which the classifier has provided weights by a words attention process, such that the weighted words of each sentence form a sentence vector; analyzing the sentence vectors by a sentence attention process to obtain a single summary vector for the sentence vectors; and, from the single summary vector, determining a score that the application is malicious.

### TECHNICAL FIELD

The present disclosed subject matter is directed to malware detection, and in particular, to malware detection from applications (APPs).

### BACKGROUND

Applications (APPs) include software designed to run on a mobile device, such as a smartphone or tablet computer. Mobile Applications frequently serve to provide users with similar services to those accessed on personal computers (PCs). APPs are generally small, individual software units with limited functions. APPs are typically installed by users on their smartphones and/or tablet computers, leading users to post feedback on various comments boards and web sites, about the APPs. These comments span a broad range, for example, from ease or difficulty of installation of the APP, to the performance of the APP.

### SUMMARY

When detecting malware on mobile devices, users leave comments on various boards and web sites. These comments are typically in the form of user reviews of an application (APP). Many of these comments show users noticing flaws in the application's behavior. These comments are, for example, from an electronic source, including web sources, such as the Google® Play Store, and the web pages associated therewith, are used as input, for example, for classifiers, which process the data of the input, to find maliciousness, such as malware in mobile devices, and provide a determination of whether the application is malicious or benign.

Embodiments of the disclosed subject matter are directed to malware detection from applications, based on observed application behaviors.

Embodiments of the disclosed subject matter are directed to systems and computerized and computer-implemented methods, which operate to detect malicious applications (APPs). Methods performed on a suitably designed computerized system, include computerized and computer-implemented methods, such as a method for detecting a malicious application (APP). The method comprises: obtaining text associated with an application; inputting a representation of the text into a classifier; and, the classifier processing the representation of the text. The classifier processes the representation of the text by processes including: applying weights to words of the text for which the classifier has provided weights by a words attention process, such that the weighted words of each sentence form a sentence vector; analyzing the sentence vectors by a sentence attention process to obtain a single summary vector for the sentence vectors; and, from the single summary vector, determining a score that the application is malicious.

Optionally, the method is such that the text associated with the application is obtained from an electronic source.

Optionally, the method is such that the text includes at least one sentence including in least one word in plain text.

Optionally, the method is such that the at least one sentence is placed into a document associated with the application.

Optionally, the method is such that the representation of the text includes a BERT (Bidirectional Encoder Representations from Transformers) embedding of the document.

Optionally, the method is such that the words attention process includes: converting each sentence in the document to a set of vectors; reweighting the words of each sentence; and, forming new sentence vectors from the reweighted words.

Optionally, the method additionally comprises: receiving the new sentence vectors for the analyzing by the sentence attention process.

Optionally, the method is such that the sentences attention process includes: transforming sentence data from the new sentence vectors into input parameters, and applying the input parameters in self-attention layers; receiving the output of the self-attention layers and transforming the output to obtain latent representations of residual layers; obtain a result of the residual layers and aggregate the result by average pooling to provide the single summary vector for each document; and, analyzing the single summary vector to obtain a score for maliciousness of the application associated with each document.

Optionally, the method additionally comprises: providing a score of whether the application is malicious or benign by comparing the score for maliciousness of the application associated with each document against a threshold value.

Optionally, the method is such that, the parameters include Value (V), Keys (K) and Queries (Q).

Optionally, the method is such that the analyzing the single vector includes applying a sigmoid transform to the single vector to obtain the score for maliciousness.

Embodiments of the disclosed subject matter are directed to a method for detecting a malicious application (APP). The method comprises: training a classifier comprising: selecting at least one application; obtaining text associated with the at least one application; creating a first document from the obtained text associated with the at least one application; obtaining a label for the at least one application, the label based on maliciousness of the at least one application; and, associating the obtained label for the first document associated with the at least one application.

Optionally, the method is such that, with the classifier trained, the method additionally comprises: inputting a second document associated with an application into the trained classifier; and, the trained classifier analyzes the second document to determine whether the application associated with the second document is malicious.

Optionally, the method is such that the second document is created from text associated with at least one application.

Optionally, the method is such that text is scraped from an electronic source.

Optionally, the method is such that the electronic source includes a web page of comments displayed for an application.

Optionally, the method is such that the text is plain text.

Optionally, the method is such that the at least one application includes a plurality of applications, and a first document is associated with each application of the plurality of applications.

Optionally, the method is such that the obtaining text associated with the at least one application includes scraping the text from an electronic source.

Optionally, the method is such that each first document is formed from the scraped text for each application, and the electronic source includes a web page of comments displayed for each application.

This document references terms that are used consistently or interchangeably herein. These terms, including variations thereof, are as follows.

A “computer” includes machines, computers and computing or computer systems (for example, physically separate locations or devices), servers, computer and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location (e.g., smart phone, personal digital assistant (PDA), mobile telephone or cellular telephone).

A “server” is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine, a software based emulation of a computer.

An “Application” (APP), includes executable software, and optionally, any graphical user interfaces (GUI), through which certain functionalities may be implemented.

A “client” is an Application (APP) that runs on a computer, workstation or the like and may rely on a server to perform some of its operations or functionality.

Unless otherwise defined herein, all technical and/or scientific terms used herein have the same meaning as commonly understood by one of ordinary skill in the art to which the disclosed subject matter pertains. Although methods and materials similar or equivalent to those described herein may be used in the practice or testing of embodiments of the disclosed subject matter, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present disclosed subject matter are herein described, by way of example only, with reference to the accompanying drawings. With specific reference to the drawings in detail, it is stressed that the particulars shown are by way of example and for purposes of illustrative discussion of embodiments of the disclosed subject matter. In this regard, the description taken with the drawings makes apparent to those skilled in the art how embodiments of the disclosed subject matter may be practiced.

Attention is now directed to the drawings, where like reference numerals or characters indicate corresponding or like components. In the drawings:

FIG. 1A is a diagram illustrating a system environment in which an embodiment of the disclosed subject matter is deployed;

FIG. 1B is a block diagram of a system in accordance with an embodiment of the disclosed subject matter;

FIG. 2 is a flow diagram of a method for a training phase for a classifier in accordance with embodiments of the disclosed subject matter;

FIG. 3 is a diagram of a web page hosting reviews of Applications;

FIGS. 4A and 4B are diagrams of databases used for a training phase for a classifier, resulting from a process detailed in FIG. 2;

FIG. 5A is a diagram of the layers of the SERTA classifier of the disclosed subject matter;

FIG. 5B is a diagram of the architecture for the Attention Later and the Sentences Layer of the SERTA classifier of the disclosed subject matter;

FIG. 5C is a diagram of the words attention layer of the SERTA classifier of FIG. 5B;

FIGS. 6A and 6B are a flow diagram of a method for a production phase for a classifier of FIGS. 5A to 5C in accordance with embodiments of the disclosed subject matter; and,

FIG. 7 is a diagram showing words being weighted by the classifier.

Appendix A to Appendix D are attached to this document.

### DETAILED DESCRIPTION OF THE DRAWINGS

Before explaining at least one embodiment of the disclosed subject matter in detail, it is to be understood that the disclosed subject matter is not necessarily limited in its Application to the details of construction and the arrangement of the components and/or methods set forth in the following description and/or illustrated in the drawings. The disclosed subject matter is capable of other embodiments or of being practiced or carried out in various ways.

As will be appreciated by one skilled in the art, aspects of the present disclosed subject matter may be embodied as a system, method or computer program product. Accordingly, aspects of the present disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosed subject matter may take the form of a computer program product embodied in one or more non-transitory computer readable (storage) medium(s) having computer readable program code embodied thereon.

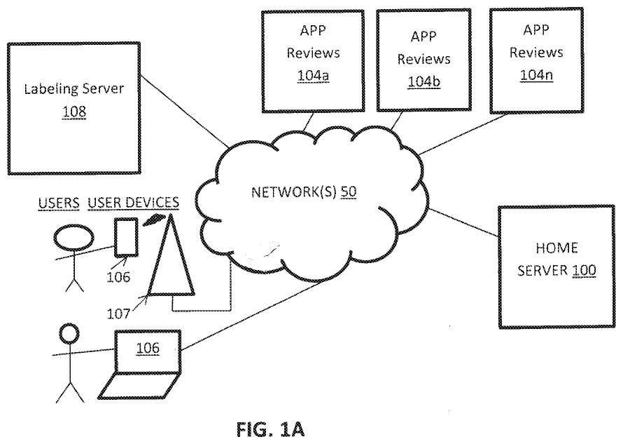

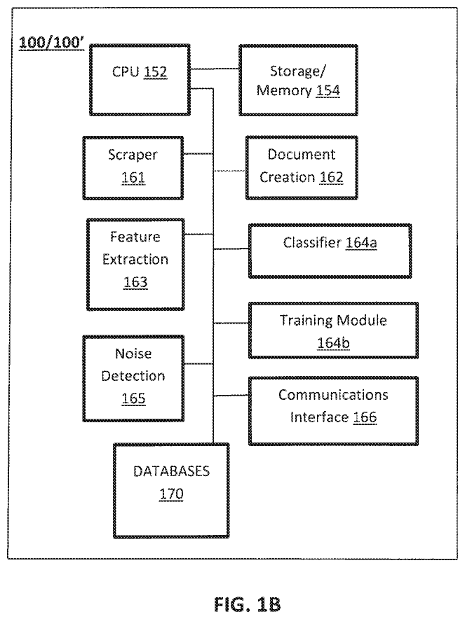

Reference is now made to FIG. 1A, which shows an exemplary operating environment, including a network(s) 50 (hereinafter “network”), to which is linked a home server (HS) 100, also known as a home computer, a main server or main computer, these terms used interchangeably herein. The home server 100 also supports a system 100′, either alone or with other, computers, including servers, components, and Applications, e.g., client Applications, associated with the home server 100, as detailed below. The home server 100 and the system 100′ (the system 100′ within or partially within the home server 100) perform the various processes in accordance with the present disclosure, as detailed below. The home server 100 functions to train a classifier, for example the SERTA classifier, detailed below. With the classifier trained, the home server 100 is such that it receives data, for example, user reviews from a source associated with a data object, such as an Application (APP) (hereinafter referred to as an APP), and analyzing the review to determine whether the APP is malicious, e.g. malware, or non-malicious, e.g., benign.

The home server (HS) 100 is of an architecture that includes one or more components, engines, modules and the like, for providing numerous additional server functions and operations. The home server (HS) 100 may be associated with additional storage, memory, caches and databases, both internal and external thereto. For explanation purposes, the home server (HS) 100 may have a uniform resource locator (URL) of, for example, www.example.hs.com. While a single home server (HS) 100 is shown, the home server (HS) 100 may be formed of multiple servers and/or components.

The network 50 is, for example, a communications network, such as a Local Area Network (LAN), or a Wide Area Network (WAN), including public networks such as the Internet. As shown in FIG. 1A, the network 50 is, for example, the Internet. The network 50, although shown as a single network, may be a combination of networks and/or multiple networks including, for example, in addition to the Internet, one or more cellular networks, wide area networks (WAN), and the like. “Linked” as used herein includes wired and/or wireless links, either direct or indirect, and placing computers, including, servers, components, modules and databases, and the like, in electronic and/or data communications with each other, either directly or indirectly.

Servers 104a-104n and other computerized components (represented collectively by servers 104a-104n), are linked to the network 50. These servers 104a-104n hold reviews, for example, in natural language, such as English, French, German, Chinese, Japanese, Hebrew, Arabic, and the like, and in plain text, or free text (hereinafter “plain text” and “free text” are used interchangeably and collectively referred to as “plain text”), received from user devices 106a, 106b, linked to the network 50 (user device 106a communicating with the network 50 via a cellular tower 107). The reviews can be scraped or otherwise obtained, for example, in natural language and plain text, from the servers 104a-104n (e.g., the web pages, web postings or the like, hosted by the servers 104a-104n). For example, one or more of the servers 104a-104n may be for Google® Play™ (https://play.google.com/).

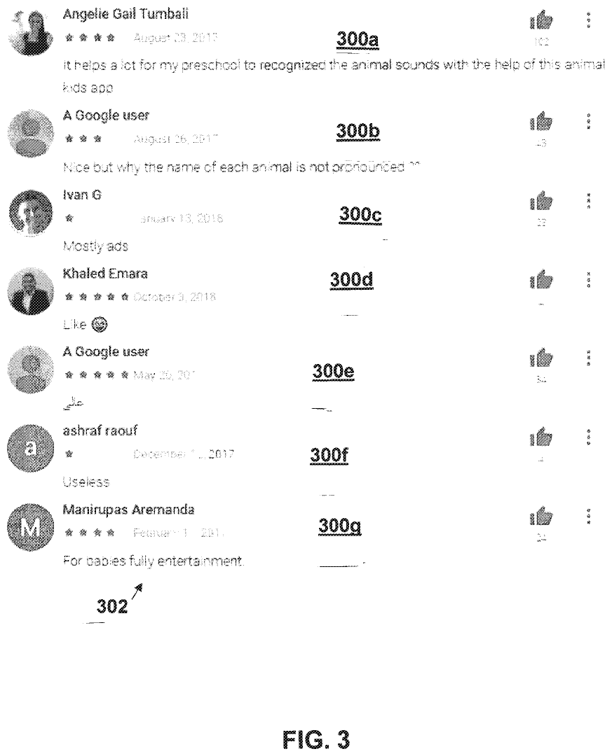

Google® Play™ is an electronic, e.g., Internet or web, store or source, widely used for android APPs. Each APP in the store has a unique name (APP package name), and additional set of metadata. A portion of the metadata includes, for example, the various user reviews 300a-300g (FIG. 3) of the APP. The user reviews are composed of a title, text and the user info.

A labeling server 108 is also linked to the network 50. The labeling server 108 provides labels for each APP analyzed by the system 100′. The labels are, for example, labels indicative of malicious or non-malicious nature of the APP. An example labeling server is one which operates the algorithm for SandBlast Mobile™ from Checkpoint Software Technologies Ltd. of Tel Aviv, Israel.

FIG. 1B shows an example architecture for the system 100′, for example, residing in the home server 100. While the system 100′ is shown in the home server 100, the components, modules and the like, of the system 100′ do not all have to reside in the home server 100, and may be external to the home server 100, and linked thereto. The system 100′ is configured, for example, to operate in multiple phases, such as two phases, a “training phase” and a “production phase”.

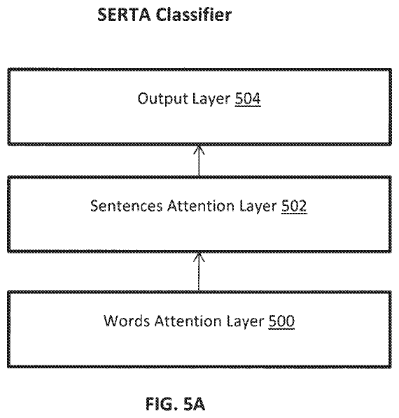

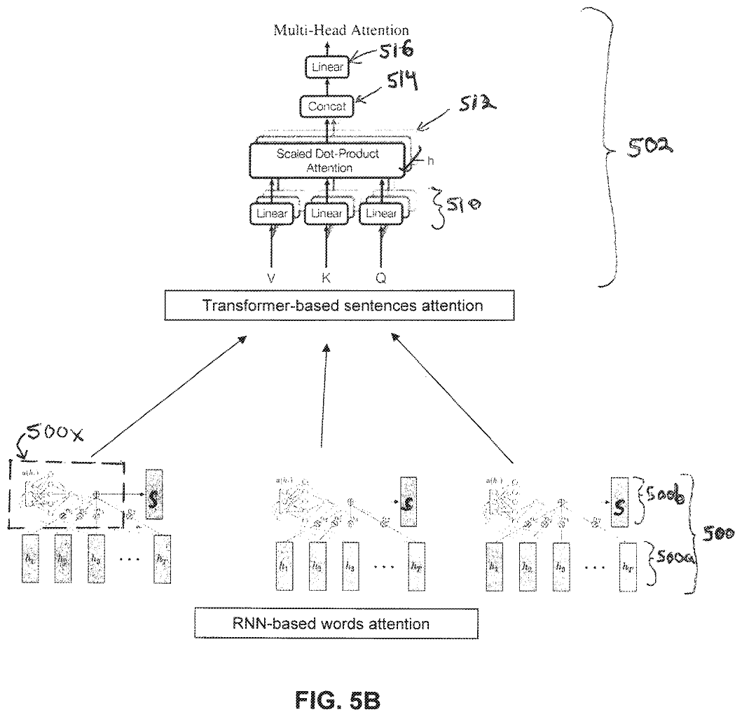

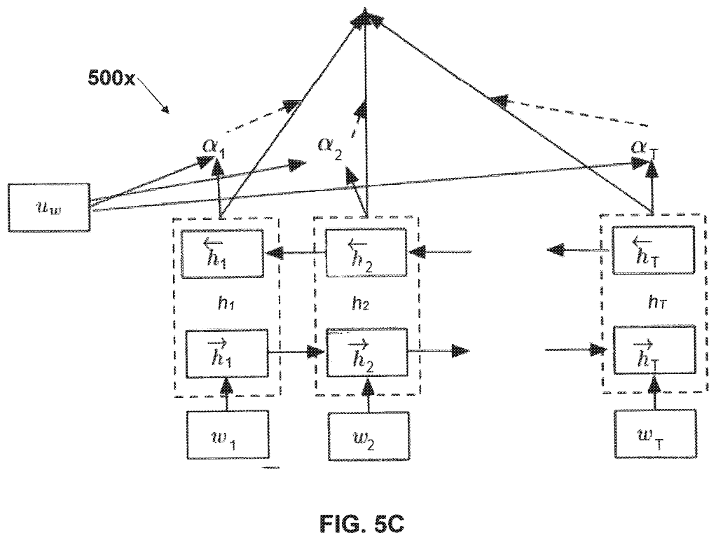

The system 100′ includes processors in a central processing unit (CPU) 152 linked to storage/memory 154. The CPU 152 is in turn, linked to components (computerized components or modules), such as a scraper 161, document creator 162, feature extractor 163, a classifier 164a, for example, a SERTA classifier detailed below and shown in FIGS. 5A, 5B, 5C, 6A, 6B and 7), a training module 164b for the classifier 164a, a noise detector 165, which is optional depending on the classifier used, a communications interface 166 and databases 170. While these components 152, 154, 161-166, and 170, are the most germane to the system 100′, other components are permissible. As used herein, a “module”, for example, includes a component for storing instructions (e.g., machine readable instructions) for performing one or more processes, and including or associated with processors, e.g., the CPU 152, for executing the instructions.

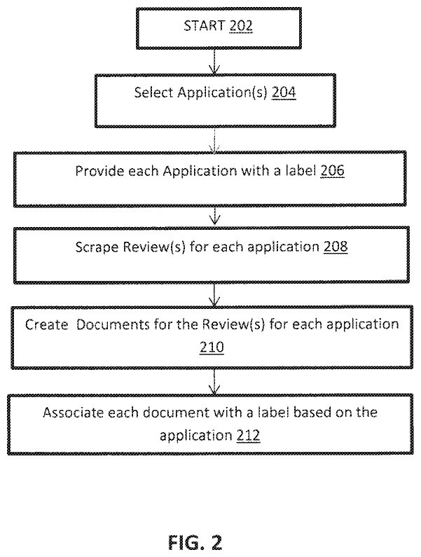

The CPU 152 is formed of one or more processors, including hardware processors, and performs processes, including the disclosed processes of FIG. 2 and detailed below. The processes of FIG. 2 may be in the form of programs, algorithms and the like. For example, the processors of the CPU 152 may include x86 Processors from AMD (Advanced Micro Devices) and Intel, Xenon® and Pentium® processors from Intel, as well as any combinations thereof.

The storage/memory 154 is associated with the CPU 152, and is any conventional storage media. The storage/memory 154 also includes machine executable instructions associated with the operation of the CPU 152 and the components 161-166, and 170, along with the processes and subprocesses shown in FIG. 2, detailed herein. The processors of the CPU 152 and the storage/memory 154, although shown as a single component for representative purposes, may be multiple components, and may be outside of the home server 100 and/or the system 100′, and linked to the network 50.

The scraper 161, for example, obtains reviews, by collecting data from the web pages, web sites and other electronic documents which host the reviews for the various APPs. For example, to collect reviews from the Google Play/Google Play Store, an open source library, such as https://github.com/facundoolano/google-play-scraper (GP scraper), may be used. This open-source library enables retrieving the reviews of a specific package (see readme.md file in repo for details on format of data).

The document creator 162, or document creation module, takes the scraped reviews, for example, for each APP, and places these reviews into a single unit, referred to herein as a “document”, which can be analyzed by the classifier 164a.

The feature extractor 163, functions to extract text of the comments, for example, words, numbers, characters, or combinations thereof as text, in plain language, collectively known as raw data, regardless of language. This raw text is input for pre-trained BERT (Bidirectional Encoder Representations from Transformers) embedding functionality for textual pre-processing, whenever the SERTA network is used as the classifier. BERT is described, for example, in Chris McCormick and Nick Ryan, “BERT Word Embeddings Tutorial”, May 14, 2019 (https://mccormickml.com/2019/05/14/BERT-word-embeddings-tutorial/) (20 Pages) (hereinafter referred to as, “Chris McCormick and Nick Ryan, ‘BERT Word Embeddings Tutorial’”), and which is incorporated by reference herein, and attached hereto as Appendix A.

The classifier 164a is a computerized component which analyzes the input documents and determines whether they are, or their probability for being, indicative that the associated APP is malicious and/or malware, or otherwise benign. The classifier can be one or more neural networks, and may also be a classifier known as SERTA. The SERTA classifier is shown in FIGS. 5A-7, detailed below. The classifier 164a is trained by a training module 164b, which relies on language indicative of a malicious or non-malicious APP to train the classifier 164a. Other suitable classifiers may be, for example, SVM-based classification or trees based like XGboost or a Random Forest. In such cases coding of the text is required (e.g., TFIDF (term frequency-inverse document frequency—a numerical statistic that is intended to reflect how important a word is to a document in a collection or corpus), in cases when using Bag of Words (BoW) approach) or even learning topics in the data prior to classification as a feature extraction phase.

A noise detector 165 or noise detection module functions as a wrapper at the training phase for noise removal and reinforcing a better training phase. The noise detector 165 is optional, depending on the classifier used, and is not applied in cases where the SERTA classifier is used as the classifier 164a for the system 100′. For example, CLEANLAB, a machine learning python package for learning with noisy labels and finding label errors in datasets, may be used for the noise detector 165, which prunes noisy labels data based on a framework of confident learning. CLEANLAB is disclosed, for example, in C. Northcutt, et al., “Confident Learning: Estimating Uncertainty in Dataset Labels”, v3, Sep. 4, 2020, pp. 1-37 (https://17.curtisnorthcutt.com/cleanlab-python-package or arXiv:1911.00068v3) (hereinafter referred to as, “C. Northcutt, et al., ‘Confident Learning: Estimating Uncertainty in Dataset Labels’”), this document incorporated by reference herein.

A communications interface 166 functions to handle all communications and data input and output from the system 100′.

Databases 170 include storage media. The databases 170 store various data for the system 100′ and processes performed by the system 100′, for example, by the training module 164b used in the training phase for the classifier 164a, and are described in greater detail below.

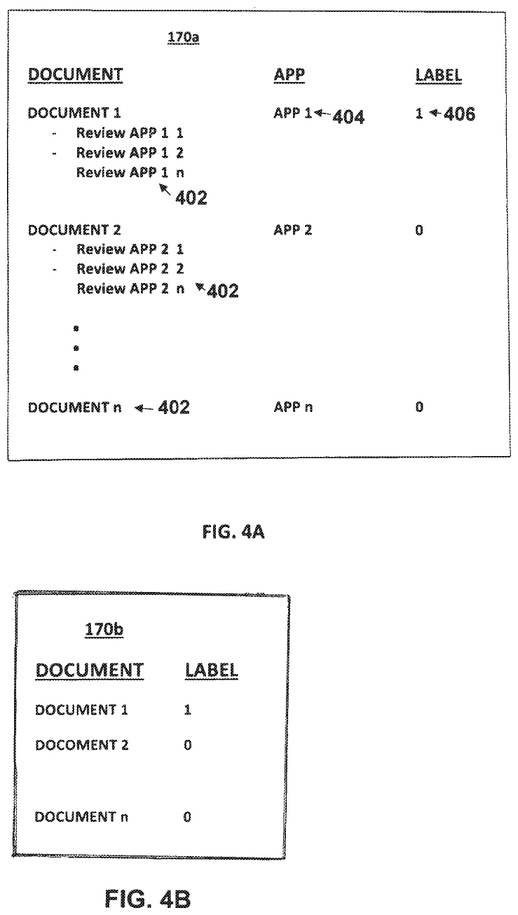

Attention is now directed to FIG. 2, which shows a flow diagram detailing a computer-implemented process in accordance with embodiments of the disclosed subject matter. Reference is also made to elements shown in FIGS. 1A and 1B. The process and subprocesses of FIG. 2 are computerized processes performed by the system 100′. The aforementioned processes and subprocesses are, for example, typically performed automatically, and, for example, in real time. Reference is also made to the diagrams and screen shots of FIGS. 3, 4A and 4B.

The process begins at a START block 202. At this block, preprocessing of text is performed depending on classifier type. Additionally, a sufficient number of APPs, which are malicious and benign, have been associated with a labeling process, algorithm, or the like, for the training phase for the classifier 164a. For example, a training set of a sample size of approximately 40,000 APPs may be used, for this training phase and labeled accordingly.

At block 204, the system 100′ designates the APPs to be used for the training phase of the classifier 164a by the training module 164b.

Moving to block 206, the system 100′ matches each selected APP with a label from the labeling server 108. The label, for example, is indicative that the APP is malicious, or benign, for example, malicious, indicated by a “1”, and benign, indicated by a “0”. The generation of labels for the training set was performed by applying a labeling process, algorithm, or the like, such as Check Point Sandblast Mobile (SBM), for each selected APP. The output of the Application of the labeling Application indicates the maliciousness of the APP (binary label), and also a sub categorization of type of malware if it is malicious (AUTO_CLICKER, ROUGH_ADNETWORK, FAKE_APP, DROPPER, INFO_STEALER, GENERIC_MALWARE_SUSPECTED, DEBUG_CERTIFICATE, DROPPER, PREMIUM_DAILER, PREMIUM_DAILER, TF_HB_APP, MRAT, ROOTING TOOL). The labeling application derives the verdict for the specific APP using the APP code and behavior, and does not analyze or otherwise evaluate the plain text of the comments/reviews for each APP. This formulation of generating labels is a form of “Distant Supervision”, which results in noisy labeled data.

The process moves to block 208, where the reviews, comments and other text, for example, in plain text, is scraped by the scraper 161. For example, reviews, comments, and other text, for each APP, for example, individual reviews 300a-300g, displayed on a web page 302, for example, as text, as shown in FIG. 3, are scraped. All of the scraped text for each individual APP is placed into a single unit, known as a document, by a document creation process, performed by the document creator 162, at block 210, to where the process moves.

At block 210, the documents are created from the scraped plain text of the reviews, typically one document for each APP. A document for an APP includes the text (e.g., plain text) scraped or otherwise obtained from one or more reviews, for the APP. Each of the documents, for the corresponding APP, is used in the training phase by the training module 164b, for the classifier 164a, one of the classifiers which may be, for example, the SERTA classifier (detailed below), although other classifiers may also be used, to determine maliciousness of the APP based on the text of the reviews therefor. For example, document boundaries for each of the created documents may be defined by the Google Play (GP) web page/web site (an electronic source), as shown in FIG. 3.

A database 170a showing the documents 402 (formed of one or more reviews for each APP (in plain text)), the APP 404 associated with each document 402, and the label 406 for the APP 404, is shown in FIG. 4A.

Moving to block 212, each document is associated with the label of the corresponding APP. The database 170b showing this association is shown in FIG. 4B. With each document having an associated label, this data (documents and associated labels) is fed (input) into a training process (for example, by the training module 164b) for a classifier 164a, which detects future malware based on reviews (e.g., documents in natural language and including comments in plain text).

The classifier 164a can now be trained, and once trained, can accept input of documents in a production phase. An example classifier 164a is, for example, a SERTA classifier, detailed below, and shown in FIGS. 5A-7.

SERTA Classifier

SERTA is a hierarchical attention-based deep learning system, which relies on pre-trained words embedding (e.g., BERT embedding), which is used for modeling the GP-reviews data. The SERTA architecture is designed, for example, for modeling the reviews data. The main features of SERTA are the learning of “in context words” with attention filtering processes while respecting the assumed independency between the various reviews (comments) of a given input document. This architecture typically also accommodates misspellings and multiple languages, by utilizing BERT embedding as detailed in Chris McCormick and Nick Ryan, “BERT Word Embeddings Tutorial”. Alternately, other classifiers, such as Support Vector Machines (SVM) or trees based like XGboost or a Random Forest or Neural Networks, may be operated jointly with a process of pruning of noisy labeled data during the training process. For example, one pruning process may be CLEANLAB, as disclosed above.

A block diagram of the SERTA classifier is shown in FIG. 5A. The SERTA Classifier is formed of three layers, a words attention layer 500, a sentences attention layer 502 and an output layer 504. The order in which the layers process documents is shown in the direction of the mows.

The architecture of the SERTA classifier is shown in FIGS. 5B (words attention layer 500, a sentences attention layer 502) and 5B (a detail view of the words attention layer 500). Conceptually, the classifier contains hierarchically two levels of attention (attention levels or attention layers, “levels” and “layers” used interchangeably herein) or parts, one at a words (words attention) layer (level) 500, and one over a sentences (sentences attention) layer (level) 502. The choice of basing the modeling on attention mechanisms in neural networks is due to the fact that not all data in the comments document is relevant for classification and the attention mechanism performs by data-dependent adaptive filtering. The word layers 500 and sentence layers, including their respective sublayers 500a, 500b, 510, 512, 514, 516, are, for example, in accordance with Vaswani, et al., “Attention Is All You Need”, in, 31^{st} Conference on Neural Information Processing Systems (NIPS 2017) Long Beach, Calif.”, (15 Pages) (https://arxiv.org/abs/1706.03762) (hereinafter referred to as, “Vaswani, et al., ‘Attention Is All You Need’”), which is incorporated by reference herein, and is attached hereto as Appendix B, with differences specifically described herein.

Focusing on the words attention operation, at the words attention layer 500, each sentence, for example, is formed of one or more words w₁ to w_{T}. The words w₁ to w_{T} are then represented by BERT embedding, and subsequently converted into a new set of corresponding vectors h₁ to h_{T}, for example, via a bi-directional Recurrent Neural Network (RNN), at a first words attention sublayer 500a. The RNN, is, for example, composed of LSTM (long term-short term memory) or GRU (gated recurrent unit) type cells. This step is meant to redistribute input embedding vectors to better follow the syntax of the comments. Next, a second or upper attention sublayer 500b over the resulted new word vectors (h₁ to h_{T}) is applied. For example, this attention sublayer 500b can be implemented by using a context vector, which is learned during training phase and performs as a “fixed query” for important indicative words. Based on this attention layer 500, the words h₁ to h_{T} are now reweighted based on the aforementioned attention. This process is further detailed below.

The attention-based weighted words of each sentence are aggregated to form a new sentence vector, by each of the word attention mechanisms 500x, as shown in FIG. 5C. The words attention mechanism 500x accounts for the fact that not all words contribute equally to the representation of the sentence meaning. As a result, the attention mechanism 500x is used to extract such words that are important to the meaning of the sentence, and aggregate the representation of those informative words to form a new representative sentence vector. The fixed query based attention and aggregation are described in Equations 1.1, 1.2, and 1.3:

$$\begin{matrix}{u}_{t} = tanh ( {W}_{ω} {h}_{t} + {b}_{ω} ) & ( 1.1 ) \\ {α}_{t} = \frac{exp ( {u}_{t}^{T} {u}_{ω} )}{{Σ}_{t} exp ( {u}_{t}^{T} {u}_{ω} )} & ( 1.2 ) \\ s = {\sum }_{t} {α}_{t} {h}_{t} & ( 1.3 )\end{matrix}$$

where u_{ω} and s represent the context vector (the learned “fixed query”) and the resulted aggregated sentence, respectively. Additionally, W_{ω} and b_{ω} are transformation matrix and bias vector to be learned, respectively, hₜ is a word annotation, αₜ is a normalized importance weight, and uₜ is a hidden representation of hₜ.

Initially the word annotation hₜ is feed through a one layer multilayer perceptron (MLP), a class of feedforward artificial neural networks (ANNs), to get uₜ as a hidden representation of hₜ. The importance of the word is then measured as the similarity of uₜ with a word level context vector u_{□} to get a normalized weight αₜ through a softmax function, for example, as detailed in https://en.wikipedia.org/wiki/Softmax_function (8 Pages), which is incorporated by reference herein, and attached hereto as Appendix C. After that, the sentence vector s (Equation 1.3) is computed, as a weighted sum of the word annotations based on the weights. The context vector u_{□} can be seen as a high level representation of a fixed query “what is the informative word”, over the words. The word context vector u_{□}is randomly initialized and jointly learned during the training process. This process, including the equations and FIG. 5B, is, for example, in accordance with that in, Z. Yang, et al., “Hierarchical Attention Networks for Document Classification”, in, Proceedings of the 2016 Conference of the North American Chapter of the Association for Computational Linguistics: Human Language Technologies, June 2016, pages 1480-1489 (https://www.aclweb.org/anthology/N16-1174/) (hereinafter referred to as, “Z. Yang, et al., ‘Hierarchical Attention Networks for Document Classification’”), this document incorporated by reference herein.

Per document, the result of this word-level attention layer 500b is a set of vectors sᵢ (see Eq. 1.3) where 1≤i≤L for a document of length L. These new sentences representations are now attended by the being input into the sentences attention layer 502.

The numerical structure of the sentences attention layer 502 follows the idea of self multi-head attention, as disclosed, for example, in Vaswani, et al., “Attention Is All You Need”.

The sentences data from the previous words attention layer 500 is transformed into the parameters: value (V), a key (K), or a query (Q), via a dot product:

Λ=dot(s,W_{Λ}) (1.4)

where Λ represent V, K, and Q, and where W_{Λ} represent matrices transformation, for example, which is set during the training process. The V, K, Q parameters are, for example, linearly projected at layer (sublayer) 510, to generate all quantities in order to perform self-attention. The generated, and linearly projected, V, K, and Q, (of Eq. 1.4) are the quantities based on which the self-attention is performed by processing parameters V, K, Q in layer (sublayer) 512, a self-attention layer, via the following equation:

$$Attention ( Q , K , V ) = softmax ( \frac{{QK}^{T}}{\sqrt{{d}_{K}}} ) V \qquad ( 1.5 )$$

where d_{K} is the dimension of the key vectors as disclosed in Vaswani, et al., “Attention Is All You Need”. These transformations of Eqs. (1.4-1.5) can be done independently h-times and so become a multi-head transformations. Often h>1 is used and typically set to 8 to result in a higher resolution of attention as disclosed, for example, in, Vaswani, et al., “Attention Is All You Need”. In cases where h>1, the results vectors of Eq. 1.5, (where each of which is a set of document length number of vectors with predetermined output size which is often set similar to the size of the corresponding input vectors or some predetermined fraction of it, based on the value of h) are concatenated at layer (sublayer) 514, such that each sentence vector is now composed of h different attended vectors via Eq. 1.5. The output of this self-attention layer and concatenation layer 514 is further transformed via residual layers (sublayers) 516, which serve to obtain the respective latent representations of the self-attended sentences. Finally, the result of the residual layers 516, for example, as detailed in S. Sahoo, “Residual blocks—Building blocks of ResNet”, in, Towards Data Science, Nov. 27, 2018 (7 pages), available at, haps://towardsdatascience.com/residual-blocks-building-blocks-of-resnet-fd90ca15d6ec, which, is incorporated by reference herein, is aggregated by average pooling to give a single vector per document, which is further is transformed into a score value for maliciousness as (e.g., malware), by a applying a sigmoid transformation, for example, as disclosed in, I. Pedro, “Understanding The Motivation of Sigmoid Output Units”, in, Towards Data Science, (14 Pages), at: https://towardsdatascience.com/understanding-the-motivation-of-sigmoid-output-units-e2c560d4b2c4, this document incorporated by reference herein, and attached hereto as Appendix D, which is the final sublayer of the sentences attention layer 502 of the SERTA classifier.

For this architecture of SERTA, and unlike in Vaswani, et al., “Attention Is All You Need”, where usage of Positional Encoding in order to encode the logical order of text is disclosed, with respect to the SERTA classifier, this part is omitted. This is because the order of the reviews is not relevant for the modeling performed by the SERTA classifier.

At the end of the training phase for the SERTA classifier, each document is transformed into a score value p, a number between zero and one (0≤p≤1) indicative of the extent of whether the associated APP is malicious, e.g. malware, (or benign). At this point in time, the output score p is used as an input to a system that also uses other data of a candidate APP, in order to determine its respective status of malware/benign. The given score in this case is being used as an indicative feature. Alternatively a threshold T may be learned for the output score p by using an independent threshold data set which is created in a similar way to the training set (discussed above for FIG. 2) and is of smaller size (typically of 20% of the training set size), and upon which the trained classifier is applied, and a threshold 0<T<1 for the score is determined at the point where an acceptable recall (e.g., 0.6) and precision (e.g. 0.5) is obtained. Once T is set, we declare malware for application with score of at least T and benign for APPs with scores below T. For example, the point of recall may be found as 0.6 and precision as 0.5, as obtained at T=0.8, which means that a candidate APP is determined to be malware in case where its score satisfies p≥T and benign otherwise (p<T).

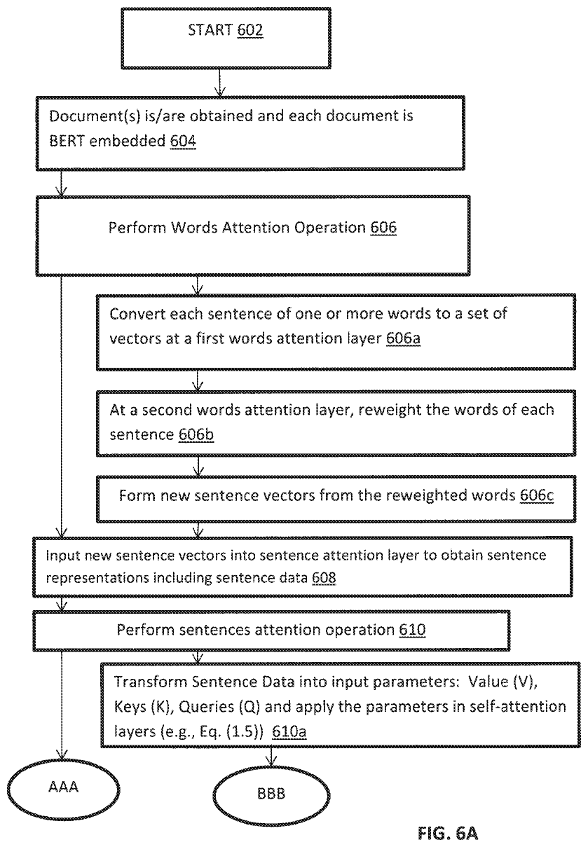

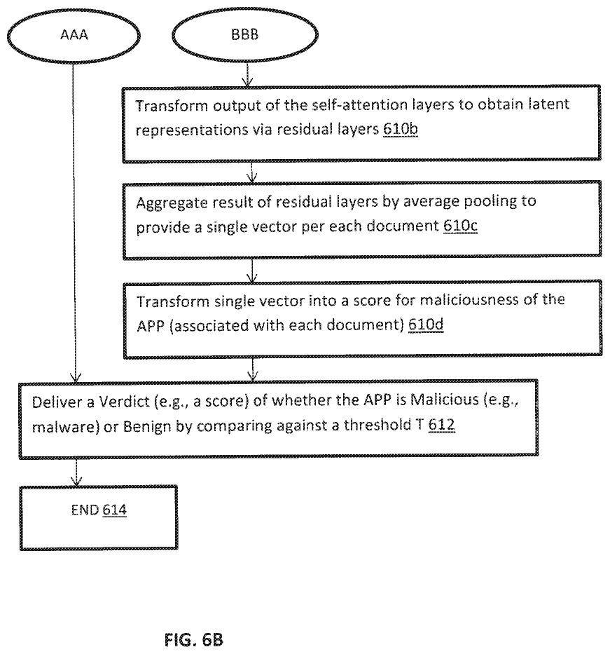

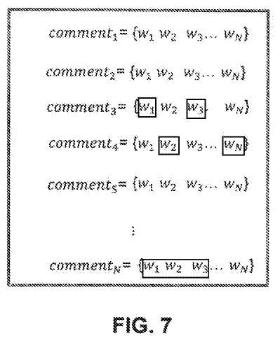

FIG. 6 shows a flow diagram of an example process for a production phase, which is performed by the classifier 164a, e.g., the SERTA classifier, upon the classifier 164a having been trained in the training phase, detailed above. The production phase performs processes, such as detecting malicious applications (APPs), which involve the layers of the classifier, the words attention layer 500, the sentences attention layer 502, and the output layer 504. Prior to analysis by the words attention layer 500, text associated with the application (APP) is obtained and a representation of the text (e.g., a BERT embedding thereof) is input into a classifier. The classifier, i.e., the SERTA Classifier, applies weights to words of the text for which the classifier has provided weights by a words attention process (at the words attention layer 500), such that the weighted words of each sentence form a sentence vector. The sentence vectors are analyzed by a sentence attention process, at the sentences attention layer 502, to obtain a single vector or single summary vector for the sentence vectors, and, from the single vector (single summary vector), determine a score that the application is malicious is determined. At the output layer 504, a verdict, in the form of a score of whether the application is malicious or benign is obtained by comparing the maliciousness score against a threshold T. The threshold T is in accordance with that detailed above, and is set, for example, is programmed into the SERTA Classifier.

The process begins at a START block 602, where the classifier 164a, e.g., the SERTA classifier, is trained, and the training phase is complete. A threshold value T for maliciousness, as detailed above, is set, and, for example, is programmed into the SERTA Classifier. This threshold value T is based, for example, on the level of accuracy desired for the SERTA Classifier.

The process moves to block 604, where documents to be classified as malicious (malware) or benign, for example, based on probabilities of being malicious or benign, are obtained, and BERT is applied to the documents so that they are input for the classifier 164a, i.e., the SERTA classifier of FIGS. 5A to 5C.

The process moves to block 606, formed of subprocesses 606a-606c where a words attention operation is performed, at the words attention layer 500a. At this first words attention operation, at block 606a, each sentence of one or more words w₁ to w_{T} represented by BERT embedding, is converted into a new set of corresponding vectors h₁ to h_{T}, for example, via a bi-directional Recurrent Neural Network (RNN), at a first words attention sublayer 500a. As discussed above for the SERTA classifier architecture of FIGS. 5A to 5C, the RNN, for example, may be composed of (for example) LSTM (long term-short term memory) or GRU (gated recurrent unit) type cells. This step (process) of block 606a is meant to redistribute input embedding vectors to better follow the syntax of the comments.

The process moves to block 606b, where the second or upper attention sublayer 500b, over the resultant new word vectors (h₁ to h_{T}) is applied. For example, this attention layer 500b can be implemented by using a context vector, which is learned during training phase and performs as a “fixed query” for important indicative words. Based on this attention layer, the words h₁ to h_{T} are now reweighted based on the aforementioned attention.

The process moves to block 606c, where the attention-based weighted words of each sentence are aggregated to form a new sentence vector, by each of the word attention mechanisms 500x, as shown in FIG. 5C. The words attention mechanism (of the words attention layer 500) accounts for the fact that not all words contribute equally to the representation of the sentence meaning. As a result, the attention mechanism is used to extract such words that are important to the meaning of the sentence, and aggregate the representation of those informative words to form a new representative sentence vector. The fixed query based attention and aggregation are described in Equations 1.1, 1.2, and 1.3, as provided above.

Initially, the word annotation hₜ is feed through a one layer multilayer perceptron (MLP), a class of feedforward artificial neural networks (ANNs), to get uₜ as a hidden representation of hₜ. The importance of the word is then measured as the similarity of uₜ with a word level context vector u_{□} to get a normalized weight αₜ through a softmax function (detailed above). After that, the sentence vector s (Equation 1.3) is computed, as a weighted sum of the word annotations based on the weights. The context vector u can be seen as a high level representation of a fixed query “what is the informative word”, over the words like that used in memory networks. The word context vector u_{□} is randomly initialized and jointly learned during the training process. This process, including the equations and FIG. 5B, are, for example, in accordance with those in Z. Yang, et al., “Hierarchical Attention Networks for Document Classification”.

Per document, the result of this word-level attention layer (sublayer) 500b is a set of vectors sᵢ (see Eq. 1.3) where 1≤i≤L for a document of length L. These new sentences representations, including sentence data, are now attended by being put into the sentences attention layer 502, at block 608.

For example, as shown in FIG. 7, words attention is applied to the sentence resulting in weighted words, at the words attention layer 500 of the classifier 164a, e.g., the SERTA Classifier (FIGS. 5A to 5C). For example, weighted words are indicated by square boxes, in each sentence “comment”.

Also at block 608, the process is such that these new sentences representations, based on their sentence data, are now attended by the being input into the sentences attention layer 502. Sentence attention is now performed.

The process moves to block 610, where sentence attention is performed, by subprocesses 610a-610d. At block 610a, the sentences data from the new sentence representations, of the previous words attention layer 500, is transformed into the parameters: value (V), a key (K), or a query (Q), via a dot product of Equation 1.4 above. The transforming of the sentence data into input parameters: Value (V), Keys (K), Queries (Q), and applying the parameters Q, K, V, in self-attention layers, is performed in layer (sublayer) 512, as per Equation 1.5 above.

These transformations of Eqs. (1.4-1.5) may, for example, be done independently h times, and as such, become a multi-head transformations. Often h>1 is used and typically set to 8 to result in an higher resolution of attention as discussed, for example, in Vaswani, et al., “Attention Is All You Need”, in 31^{st} Conference on Neural Information Processing Systems (NIPS 2017), (15 Pages) Long Beach, Calif. In cases where h>1, the results vectors of Eq. 1.5, (where each of which is a set of document length number of vectors with predetermined output size which is often set similar to the size of the corresponding input vectors or some predetermined fraction of it, based on the value of h) are concatenated at layer (sublayer) 514, such that each sentence vector is now composed of h different attended vectors via Eq. 1.5.

The process moves to block 610b, where the output of this self-attention (sentence) layer 512 and concatenation layer 514 is further transformed to obtain latent representations via residual layers (sublayers) 516. At block 610c, the result of the residual layers 516 (e.g., S. Sahoo, “Residual blocks—Building blocks of ResNet”) is aggregated by average pooling to provide a single vector (single summary vector) for each document. At block 610d each single vector (single summary vector) is transformed into a score for maliciousness of the APP, for example, the APP associated with each document (e.g., one APP is associated with one document). This transformation is performed, for example, by a applying a sigmoid transformation (such as the sigmoid transformation of I. Pedro, “Understanding the Motivation of Sigmoid Output Units”, detailed above), which is the final sublayer of the sentences attention layer 502 of the SERTA Classifier.

Based on the score determined at block 610d, the score is fed to the output layer 504, where a verdict, for example, in the form of a score, which is, for example, obtained upon a comparison to a Threshold Value T (as detailed above), as to whether the APP is malicious (e.g., malware) or benign, is rendered by the system, at block 612. The process ends at block 614. This process may be repeated for as long as desired.

For example, hardware for performing selected tasks according to embodiments of the invention could be implemented as a chip or a circuit, or a virtual machine or virtual hardware. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. A non-transitory computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable non-transitory storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method for detecting a malicious application (APP) comprising:
obtaining text associated with an application;
inputting a representation of the text into a classifier; and,
the classifier processing the representation of the text including:
applying weights to words of the text for which the classifier has provided weights by a words attention process, such that the weighted words of each sentence form a sentence vector;
analyzing the sentence vectors by a sentence attention process to obtain a single summary vector for the sentence vectors; and,
from the single summary vector, determining a score that the application is malicious.

2. The method of claim 1, wherein the text associated with the application is obtained from an electronic source.

3. The method of claim 2, wherein the text includes at least one sentence including in least one word in plain text.

4. The method of claim 3, wherein the at least one sentence is placed into a document associated with the application.

5. The method of claim 4, wherein the representation of the text includes a BERT (Bidirectional Encoder Representations from Transformers) embedding of the document.

6. The method of claim 5, wherein the words attention process includes:
converting each sentence in the document to a set of vectors;
reweighting the words of each sentence; and,
forming new sentence vectors from the reweighted words.

7. The method of claim 6, additionally comprising: receiving the new sentence vectors for the analyzing by the sentence attention process.

8. The method of claim 6, wherein the sentences attention process includes:
transforming sentence data from the new sentence vectors into input parameters, and applying the input parameters in self-attention layers;
receiving the output of the self-attention layers and transforming the output to obtain latent representations of residual layers;
obtain a result of the residual layers and aggregate the result by average pooling to provide the single summary vector for each document; and,
analyzing the single summary vector to obtain a score for maliciousness of the application associated with each document.

9. The method of claim 8, additionally comprising: providing a score of whether the application is malicious or benign by comparing the score for maliciousness of the application associated with each document against a threshold value.

10. The method of claim 8, wherein the parameters include Value (V), Keys (K) and Queries (Q).

11. The method of claim 8, wherein the analyzing the single vector includes applying a sigmoid transform to the single vector to obtain the score for maliciousness.

12. A method for detecting a malicious application (APP) comprising:
training a classifier comprising:
selecting at least one application;
obtaining text associated with the at least one application;
creating a first document from the obtained text associated with the at least one application;
obtaining a label for the at least one application, the label based on maliciousness of the at least one application; and,
associating the obtained label for the first document associated with the at least one application.

13. The method of claim 12, additionally comprising:
inputting a second document associated with an application into the trained classifier; and,
the trained classifier analyzing the second document to determine whether the application associated with the second document is malicious.

14. The method of claim 12, wherein the second document is created from text associated with at least one application.

15. The method of claim 14, wherein the text is scraped from an electronic source.

16. The method of claim 15, wherein the electronic source includes a web page of comments displayed for an application.

17. The method of claim 15, wherein the text is plain text.

18. The method of claim 12, wherein the at least one application includes a plurality of applications, and a first document is associated with each application of the plurality of applications.

19. The method of claim 18, wherein the obtaining text associated with the at least one application includes scraping the text from an electronic source.

20. The method of claim 19, wherein each first document is formed from the scraped text for each application, and the electronic source includes a web page of comments displayed for each application.
